(19) United States
(12) Patent Application Publication
(10) Pub. No.: US 2015/0024642 A1
(43) Pub. Date: Jan. 22, 2015

(54) BONDABLE ELECTRICAL CONNECTOR AND METHOD OF UTILIZING SAME

(71) Applicant: Pilkington Group Limited, Lathom (GB)

(72) Inventors: Charles Ash, Perrysburg, OH (US); Charles Sitterlet, Northwood, OH (US)

(21) Appl. No.: 13/261,940

(22) PCT Filed: Feb. 8, 2013
(86) PCT No.: PCT/GB2013/050294

§ 371 Date: Aug. 14, 2014

Related U.S. Application Data
(60) Provisional application No. 61/604,655, filed on Feb. 29, 2012.

(51) Int. Cl. H01R 43/02; B23K 1/002; B23K 1/00; H01R 13/02; B60J 1/00

(52) U.S. Cl. CPC H01R 43/02; H01R 13/02; B60J 1/00; B23K 1/0008; B23K 1/002; H01R 43/0263
USPC 439/884; 219/616

(57) ABSTRACT

An electrical connector (10) is particularly suitable for bonding to a vehicle window (12), wherein the vehicle window (12) and the electrical connector (10) are disposed on/in an assembly fixture and are brought into bonding contact with one another to form a vehicle window assembly (14).

### RELATED APPLICATION

This application is claiming the benefit, under 35 U.S.C. 119(e), of the provisional application filed Feb. 29, 2012 under 35 U.S.C. 111(b), which was granted Ser. No. 61/604,655. This provisional application is hereby incorporated herein by reference in its entirety.

### BACKGROUND OF THE INVENTION

The invention relates to an electrical connector to be bonded to a glass substrate, for example, a vehicle window. More specifically, the invention relates to an electrical connector particularly suitable for bonding to a vehicle window, wherein the vehicle window and the electrical connector are disposed on/in an assembly fixture and are brought into bonding contact with one another to form a vehicle window assembly.

While thousands of electrical connectors have been described in the patent literature, the number of patented electrical connectors which are bondable to glass substrates is much smaller, for example:

U.S. Pat. No. 4,721,845 describes an electrically heatable automobile glass pane having heating conductors printed onto and baked into a surface, which conductors are connected to printed-on and baked-in collecting conductors, metal strips are disposed on the baked-in collecting conductors and are electrically connected with the collecting conductors. The baked-in collecting conductors and the metal strips connected with them are furnished with a plastic coating which jointly covers them and is glued to them and to the glass surface.

U.S. Pat. No. 6,406,337 (U.S. Pat. No. 6,551,150 is a continuation of 6,406,337) describes an electrical terminal including a base pad for soldering to a glass substrate surface. The base pad has a curved perimeter that is generally circular and top and bottom surfaces. The electrical terminal also includes a securement portion having a deformable member for deforming around a conductor wire to capture and secure the conductor wire directly to the securement portion. The securement portion is configured relative to the base pad such that forces exerted by the conductor on the base pad are said to be directed to a central region of the base pad. Two or more cable/terminal assemblies can be attached to a carrier strip by breakable regions to facilitate installation.

U.S. Pat. No. 7,059,884 describes an electrical connection structure for a conductor formed on a glass surface, comprising a conductor formed on the glass surface, a cover member provided to cover at least a part of the conductor, forming a cavity between the cover member and the glass surface and having an insertion slot communicating with the cavity, and a connection member inserted into the insertion slot made of an electrically conductive material having elasticity, wherein the connection member presses the conductor by being elastically deformed in the cavity, whereby the connection member and the conductor are electrically connected.

U.S. Patent Publication No. 2009/0277671 describes a glass pane having at least one electrical functional element. The electrical functional element comprises at least one electrical conductor and at least one terminal area located at an end of the electrical conductor, wherein the electrical conductor and the terminal area are formed from an electrically conductive layer deposited on a surface of the glass pane. A terminal wire is connected to the at least one terminal area by a soldered joint by way of a metal block having a flat contact area, and the flat contact area is soldered on a corresponding terminal area.

DE 202011100906 U1 describes an electrical connector for contacting a conductive structure on a flat glass substrate by means of a lead-free solder, wherein on its side facing away from the conductive structure means for attaching a flexible conductor are arranged. The connector is further described as a solderable foot designed as a single or dual circle.

### SUMMARY OF THE INVENTION

The present invention relates to an electrical connector to be bonded to a glass substrate, for example, a vehicle window. More specifically, the invention relates to an electrical connector particularly suitable for bonding to a vehicle window, wherein the vehicle window and the electrical connector are disposed on/in an assembly fixture and are brought into bonding contact with one another to form a vehicle window assembly.

In order for an electrical connector, or other item of hardware having some degree of flexibility, to be efficiently utilized in an assembly fixture as part of a high volume manufacturing process, it has been found to be advantageous for that flexibility to be limited; that is, that it is necessary for at least a portion of the electrical connector or other item of hardware to have a certain rigidity, as expressed, for example, in terms of modulus of rigidity.

The electrical connector of the invention preferably includes:
an electrically conductive bonding portion having a modulus of rigidity>40 GPa;
an unbonded electrically conductive portion;
a first connecting portion connecting the conductive bonding portion and the unbonded conductive portion; and
a second connecting portion connected to the distal end of the unbonded conductive portion to enable electrical connection to an electrically operable device or assembly.

In addition to forming a strong bond between the bonding portion of the electrical connector and the glass substrate, the electrical connector of the invention exhibits desirable strength in the connection between the electrically conductive bonding portion and the unbonded electrically conductive portion of the invention.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a plan view of the electrical connector in accordance with the invention.

FIG. 1a is a cross-sectional view of an alternative embodiment of the electrical connector of FIG. 1 in accordance with the invention.

FIG. 2 is a plan view of the electrical connector according to the invention bonded to a vehicle window.

FIG. 3 is a perspective view of the electrical connector according to the invention disposed in an assembly fixture.

FIG. 4 is a plan view of a prior art, braided electrical connector.

### DETAILED DESCRIPTION OF THE INVENTION

The invention relates to an electrical connector 10 to be bonded to a glass substrate, for example, a vehicle window 12. More specifically, the invention relates to an electrical connector 10 particularly suitable for bonding to a glass vehicle window 12, wherein the vehicle window 12 and the electrical connector 10 are disposed on/in an assembly fixture 30 and are brought into bonding contact with one another to form a vehicle window assembly 14.

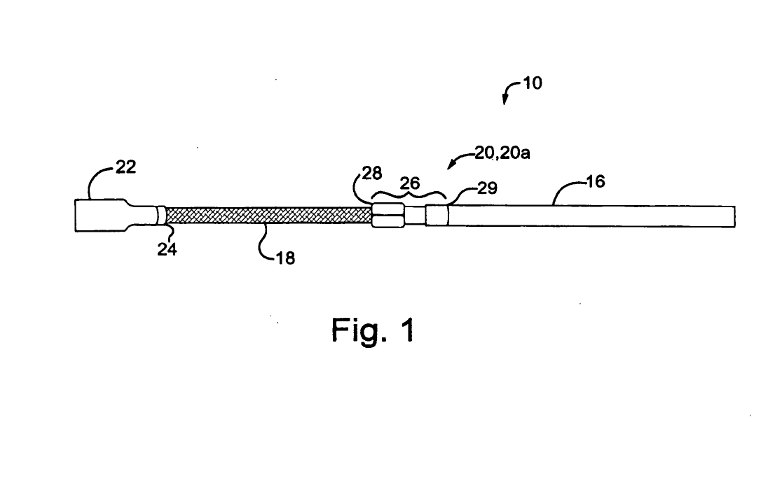

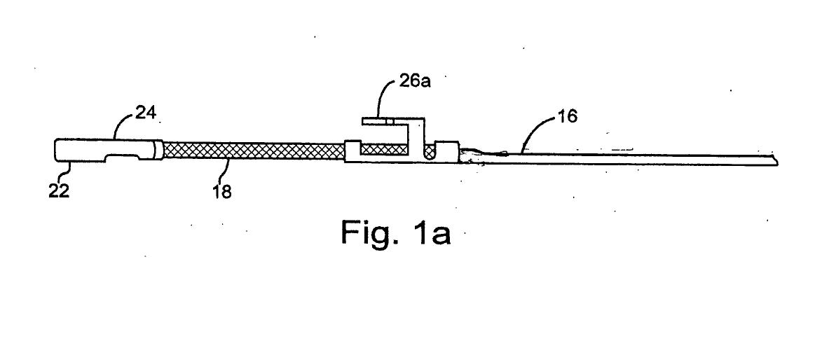

FIG. 1 shows an electrical connector to be bonded to a glass vehicle window, according to the invention, which includes as major components thereof:
an electrically conductive bonding portion 16;
an unbonded electrically conductive portion 18;
a first connecting portion 20 mechanically and electrically connecting the conductive bonding portion 16 and the unbonded conductive portion 18; and
a second connecting portion 22 mechanically and electrically connected to the distal end 24 of the unbonded conductive portion 18 to enable electrical connection of the electrical connector 10 to an electrically operable device or assembly.

The electrically conductive bonding portion 16 is an electrically conductive metal. Preferably, the electrically conductive metal includes copper and alloys of copper, although other highly electrically conductive metals may be considered.

It is an aspect of the invention that the electrically conductive bonding portion 16 of the electrical connector 10 exhibits a certain rigidity or, put another way, is not undesirably flexible. The inventors have found that for purposes of the invention it is preferred that the electrically conductive bonding portion 16 exhibit a rigidity, expressed as modulus of rigidity, >40 GPa. The modulus of rigidity, or shear modulus, is one of several quantities for measuring the stiffness of materials, generally covered by Hooke's law. The shear modulus or modulus of rigidity is concerned with the deformation of a solid when it experiences a force parallel to one of its surfaces while its opposite face experiences an opposing force, for example, friction. Modulus of rigidity is typically expressed in gigapascals (GPa). As an example, the modulus of rigidity (at room temperature) of copper is 44.7 GPa.

The unbonded electrically conductive portion 18 may be any suitable material, but is preferably an insulated highly electrically conductive wire, for example a braided or solid copper wire. Any suitable electrically non-conductive insulating material may be considered as a coating or sheath for the wire, such as a polymeric insulating material.

The electrically conductive bonding portion 16 and the unbonded electrically conductive portion 18 may be of any suitable dimension. While they are shown as being relatively equal in length and width, they may differ in dimension as requirements for a particular vehicle window dictate.

The first connecting portion 20 of the electrical connector 10 mechanically and electrically connects the conductive bonding portion 16 and unbonded conductive portion 18 thereof. Any suitable connection system may be considered, however, preferably the first connecting portion 20 includes a two-part connector 26 with one portion 28 suitable for gripping the preferably cylindrical insulated wire of the unbonded connecting portion 18, and the other portion 29 suitable for gripping the substantially flat electrically conductive metal ribbon of the electrically conductive bonding portion. In an alternative configuration shown in FIG. 1a, the two-part connector 26 may also include other electrically and/or mechanically functional structures as a component thereof, for example, a clip-type electrical connector 26a. Such two-part connector 26, 26a may be crimped, soldered, welded or otherwise securely connected to the unbonded conductive portion 18 and the conductive bonding portion 16.

In a preferred configuration, the unbonded electrically conductive portion 18 is first welded to the electrically conductive bonding portion 16 to form a welded joint. Then, a solder-bearing gripping connector portion 26 is crimped over the welded joint and heated to the solder melting temperature to form an enhanced first connecting portion 20a. Primarily, the mechanical strength of the connection between the unbonded conductive portion and the conductive bonding portions (16, 18) is “enhanced” by the connecting process just described. More particularly, the enhanced first connecting portion 20a preferably exhibits a tensile strength of at least 100N (Newtons), and a shear strength of at least 100N.

A second connecting portion 22 is connected to the distal end 24 of the unbonded conductive portion 18 of the electrical connector 10. The second connecting portion 22 is preferably grippingly connected to the preferably cylindrical insulated wire of the unbonded connecting portion 18. The second connecting portion 22 may have any configuration desirable for connection to any one of an electrically operable device or assembly such as may be disposed on a vehicle window, for example, pins, clips, and other wire assemblies.

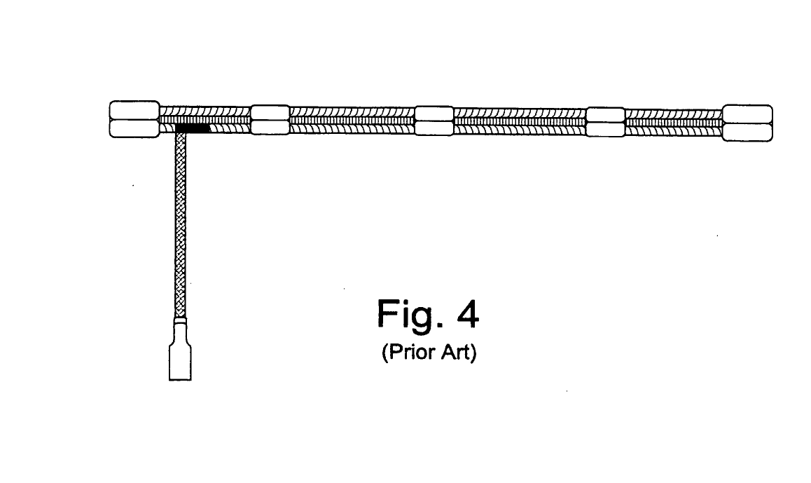

In high volume glass manufacturing operations it is desirable to automate as many portions of the manufacturing process as is practicable. For bonding items of hardware to glass, it has been found to be beneficial to use various types of electromechanical assembly fixtures 30 for this purpose. Indeed, the electrical connector 10, having certain properties of rigidity has been found to be particularly useful in an assembly process utilizing such assembly fixtures 30. Prior art electrical connectors such as is shown in FIG. 4 are too flexible, among other problems, to be regularly successfully utilized in an assembly process utilizing such assembly fixtures 30.

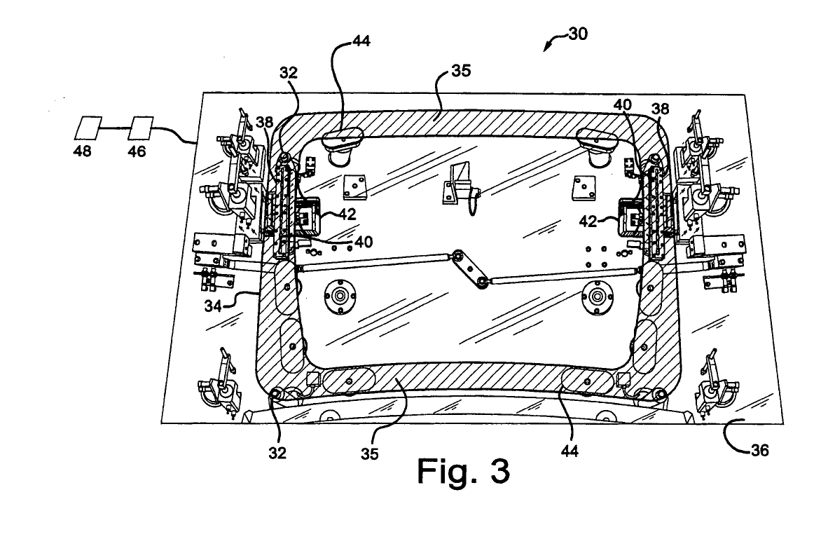

An apparatus for bonding, for example, the electrical connector 10 to a vehicle window 12 to form a vehicle window assembly 14 is illustrated in FIG. 3 and preferably includes:
an assembly fixture 30 having at least one vertical support member 32 for supporting a vehicle window 12 having a bonding surface 34, in a predetermined vertical orientation relative to a major support surface 36;
one or more assembly aids 38 proximate the major support surface 36, the assembly aid 38 comprising at least one receptacle 40 having one or more electrical connectors 10 disposed therein, and one or more induction heating devices 42 for heating one or more of: the one or more electrical connectors 10 having a predetermined amount of a solder material adhered to an electrically conductive bonding portion thereof, the electrically conductive bonding portion 16 having a modulus of rigidity>40 GPa; and the vehicle window 12, to a temperature sufficient to melt the solder material;
at least one mechanism 44 to bring the vehicle window 12 and the one or more electrical connectors 10 into bonding contact;
one or more power supply units 46 electrically connected to the one or more induction heating devices 42; and
one or more controllers 48 electrically connected to the one or more power supply units 46.

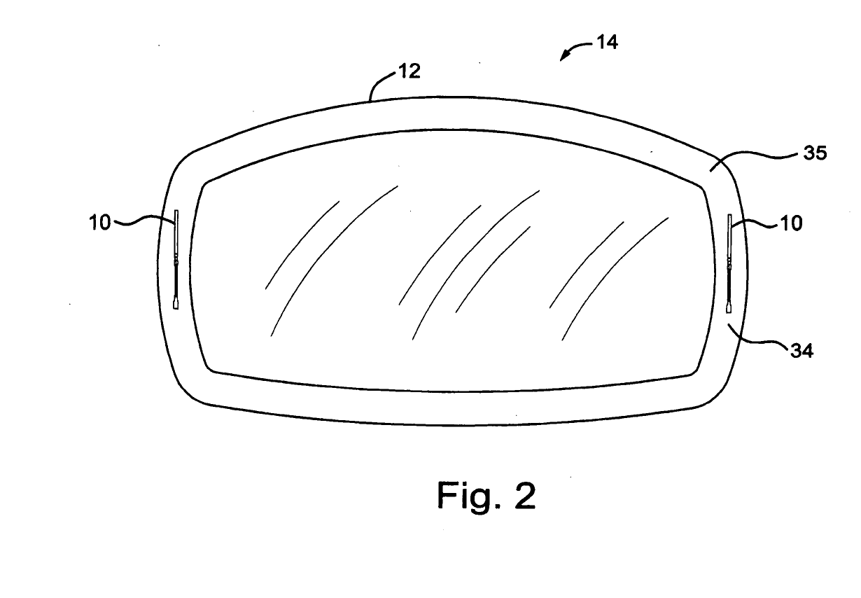

A method of forming a window assembly 14 by utilizing an automated process including one or more assembly fixtures 30 is also an aspect of the invention. Preferably, such an assembly method includes:
providing a vehicle window 12 having a bonding surface 34 preferably, a ceramic frit layer 35 is disposed on a bonding surface 34 in one or more predetermined areas, the ceramic frit preferably being disposed in the area to which the electrical connector 10 is to be bonded;
positioning the vehicle window 12 on an assembly fixture 30 in a predetermined orientation such that an electrical connector 10 positioned in a receptacle 40 formed in the assembly fixture 30, or in an assembly aid 38 proximate the assembly fixture 30, and having an electrically conductive bonding portion 16 having a modulus of rigidity>40 GPa, with a predetermined amount of solder disposed thereon, is connected to an unbonded electrically conductive portion 18 by a first connecting portion (20, 20a), and a second connecting portion 22 connected to the distal end 24 of the unbonded electrically conductive portion 18, so that the conductive bonding portion 16 of the electrical connector 10 is proximate the bonding surface 34 of the vehicle window 12;
utilizing at least one induction heating device 42 supported proximate the electrical connector 10 to supply heat to or proximate the solder, thereby heating the solder above its melting temperature;
operating a mechanism 44, which may be a vacuum device and is a component of the assembly fixture 30, to bring the bonding surface 34 of the vehicle window 12 and electrical connector 10 into bonding contact by applying a negative gaseous pressure to the vehicle window, drawing the vehicle window intimately against a resilient portion of mechanism 44; and
allowing the solder to cool, whereby the electrically conductive bonding portion 16 of the electrical connector 10 is bonded to the vehicle window bonding surface 34, forming a vehicle window assembly 14, as shown in FIG. 2.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. An electrical connector to be bonded to a glass substrate comprising:
an electrically conductive bonding portion having a modulus of rigidity>40 GPa;
an unbonded electrically conductive portion;
a first connecting portion mechanically and electrically connecting the conductive bonding portion to the unbonded conductive portion; and;
a second connecting portion mechanically and electrically connected to the distal end of the unbonded conductive portion to enable electrical connection of the electrical connector to an electrically operable device or assembly.

2. The electrical connector defined in claim 1, wherein the electrically conductive bonding portion comprises an electrically conductive metal.

3. The electrical connector defined in claim 2, wherein the electrically conductive metal comprises copper and/or alloys of copper.

4. The electrical connector defined in claim 1, wherein the first connecting portion comprises a two-part connector portion.

5. The electrical connector defined in claim 4, wherein the two-part connector portion comprises: a portion suitable for gripping the wire of the unbonded connecting portion, and another portion suitable for gripping the metal ribbon of the electrically conductive bonding portion.

6. The electrical connector defined in claim 4, wherein the two-part connector further comprises a clip-type electrical connector.

7. An apparatus for forming a vehicle window assembly comprising:
an assembly fixture having at least one vertical support member for supporting a vehicle window having a bonding surface in a predetermined vertical orientation relative to a major support surface;
one or more assembly aids proximate the major support surface, the assembly aid comprising at least one receptacle having one or more electrical connectors disposed therein, and one or more induction heating devices for heating one or more of, the one or more electrical connectors having a predetermined amount of a solder material adhered to an electrically conductive bonding portion thereof, the electrically conductive bonding portion having a modulus of rigidity>40 GPa, and the vehicle window, to a temperature sufficient to melt the solder material;
at least one mechanism to bring the vehicle window and the one or more electrical connectors into bonding contact;
one or more power supply units electrically connected to the one or more induction heating devices; and
one or more controllers electrically connected to the one or more power supply units.

8. A method of forming a vehicle window assembly comprising:
providing a vehicle window having a bonding surface;
positioning the vehicle window on an assembly fixture in a predetermined orientation such that an electrical connector positioned in a receptacle formed in the assembly fixture, or in an assembly aid proximate the assembly fixture, and having an electrically conductive bonding portion having a modulus of rigidity>40 GPa, with a predetermined amount of solder disposed thereon, is connected to an unbonded electrically conductive portion by a first connecting portion, and a second connecting portion is connected to the distal end of the unbonded electrically conductive portion, so that the bonding portion of the electrical connector is proximate the bonding surface of the vehicle window;
utilizing at least one induction heating device supported proximate the electrical connector to supply heat to or proximate the solder, thereby heating the solder above its melting temperature;
operating a mechanism which is a component of the assembly fixture to bring the bonding surface of the vehicle window and electrical connector into bonding contact; and
allowing the solder to cool, whereby the electrical connector bonding portion is bonded to the vehicle window bonding surface, forming a vehicle window assembly.

9. An electrical connector to be bonded to a glass substrate . comprising:
an electrically conductive bonding portion having a modulus of rigidity>40 GPa;
an unbonded electrically conductive portion welded to the electrically conductive bonding portion to form a welded joint and a solder-bearing gripping connector portion is crimped over the welded joint and heated to the solder melting temperature to form an enhanced first connecting portion; and
a second connecting portion connected to the distal end of the unbonded conductive portion to enable electrical connection to an electrically operable device or assembly.

10. The electrical connector defined in claim 9, wherein the enhanced first connecting portion exhibits a tensile strength of at least 100N.

11. The electrical connector defined in claim 10, wherein the enhanced first connecting portion exhibits a shear strength of at least 100N.
